(19) United States
(12) Patent Application Publication
(10) Pub. No.: US 2020/0201804 A1
(43) Pub. Date: Jun. 25, 2020

(54) I3C DEVICE TIMING ADJUSTMENT TO ACCELERATE IN-BAND INTERRUPTS

(71) Applicant: QUALCOMM Incorporated, San Diego, CA (US)

(72) Inventors: Sharon GRAIF, Zichron Yakov (IL); Lior AMARILIO, Yokneam (IL); Oren NISHRY, Bet Lham HaGlilit (IL)

(21) Appl. No.: 16/230,006

(22) Filed: Dec. 21, 2018

(51) Int. Cl. G06F 13/40; G06F 13/42; H04L 12/40

(52) U.S. Cl. CPC G06F 13/4031; H04L 12/40143; G06F 13/4291

(57) ABSTRACT

Systems, methods, and apparatus associated with a device coupled to a serial bus are described. A method data communication includes providing a clock signal on a first line of the serial bus, determining a winning device based on an address received from a second line of the serial bus during a bus arbitration procedure, determining a first sampling point for sampling a first data signal that is received from the second line of the serial bus based on timing of the clock signal and a first delay value corresponding to the winning device, and capturing a first bit of data from the second line of the serial bus at the sampling point. The serial bus may be operated in accordance with an I3C protocol.

### TECHNICAL FIELD

The present disclosure relates generally to an interface between processing circuits and peripheral devices and, more particularly, to improving latency on a serial bus that supports arbitration for access to a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

The I3C bus employs an arbitration scheme that involves the use of relatively slow open-drain line drivers. Accordingly, arbitration processes and/or opportunities can degrade latency on the serial bus. As applications have become more complex, demand for reduced response time has escalated and there is a continuing demand for improved bus management techniques that can reduce bus latency.

### SUMMARY

Certain aspects of the disclosure relate to systems, apparatus, methods and techniques that enable alerts and/or requests for bus arbitration to be sent in a first direction over a serial bus while a datagram is being transmitted in a second direction over the serial bus.

In various aspects of the disclosure, a method for data communication includes providing a clock signal on a first line of a serial bus, determining a winning device based on an address received from a second line of the serial bus during a bus arbitration procedure, determining a first sampling point for sampling a first data signal that is received from the second line of the serial bus based on timing of the clock signal and a first delay value corresponding to the winning device, and capturing a first bit of data from the second line of the serial bus at the sampling point. The serial bus may be operated in accordance with an I3C protocol.

In one or more aspects, the method includes determining a second sampling point for sampling a second data signal that is received from a third line of the serial bus based on timing of the clock signal and a second delay value corresponding to the winning device, and capturing a second bit of data from the third line of the serial bus at the second sampling point. The first sampling point may be coincident with the second sampling point or a delay may be provided between the first sampling point and the second sampling point.

In one or more aspects, the method includes delaying the first data signal using a delay line, and capturing the first bit of data from an output of the delay line that is selected using the first delay value. The first delay value may be expressed as a number of cycles of a timing signal used to generate the clock signal, or as a number of edges in a timing signal used to generate the clock signal.

In various aspects of the disclosure, an apparatus includes a bus interface configured to couple the apparatus to a serial bus having a first line configured to carry a clock signal, the bus interface including a line driver adapted to drive a second line of the serial bus. The apparatus includes a processor configured to provide the clock signal, determine a winning device based on an address received from a second line of the serial bus during a bus arbitration procedure, determine a first sampling point for sampling a first data signal that is received from the second line of the serial bus based on timing of the clock signal and a first delay value corresponding to the winning device, and capture a first bit of data from the second line of the serial bus at the sampling point.

In various aspects of the disclosure, an apparatus includes means for providing a clock signal on a first line of a serial bus, means for determining a winning device based on an address received from a second line of the serial bus during a bus arbitration procedure, means for determining a first sampling point for sampling a first data signal that is received from the second line of the serial bus based on timing of the clock signal and a first delay value corresponding to the winning device, and means for capturing a first bit of data from the second line of the serial bus at the sampling point.

In various aspects of the disclosure, a computer-readable medium stores code, instructions and/or data, including code which, when executed by a processor, causes the processor to provide a clock signal on a first line of a serial bus, determine a winning device based on an address received from a second line of the serial bus during a bus arbitration procedure, determine a first sampling point for sampling a first data signal that is received from the second line of the serial bus based on timing of the clock signal and a first delay value corresponding to the winning device, and capture a first bit of data from the second line of the serial bus at the sampling point.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 includes a timing diagram that illustrates an example of signaling on a serial bus when the serial bus is operated in a mode of operation defined by I3C specifications.

FIG. 8 is a timing diagram that illustrates an example of a transmission of a frame in an

I3C single data rate mode.

FIG. 9 is a timing diagram that illustrates an example of a transmission of a frame in an I3C high data rate mode, where data is transmitted at double data rate (DDR).

FIG. 10 illustrates address headers transmitted in accordance with I3C protocols.

FIG. 11 illustrates an apparatus that includes an application processor and multiple peripheral devices that may be adapted according to certain aspects disclosed herein.

FIG. 12 illustrates an apparatus that has been adapted to support VGI in accordance with certain aspects disclosed herein.

FIG. 13 illustrates a device that employs an I3C bus to couple various devices in accordance with certain aspects disclosed herein.

FIG. 14 illustrates certain aspects of timing related to in-band interrupts and address arbitration in accordance with certain aspects disclosed herein.

FIG. 15 is a timing diagram that illustrates a device-specific configuration of a sampling circuit in a master device that reads or interrogates a winning slave device after an arbitration process, and in accordance with certain aspects disclosed herein.

FIG. 16 illustrates a receiving circuit adapted to operate in accordance with certain aspects of the invention.

FIG. 17 illustrates a multilane apparatus adapted in accordance with certain aspects disclosed herein.

FIG. 18 is a block diagram illustrating an example of an apparatus employing a processing circuit that may be adapted according to certain aspects disclosed herein.

FIG. 19 is a second flowchart illustrating certain aspects of an arbitration priority scheme for low latency applications coupled to a serial bus in accordance with certain aspects disclosed herein.

FIG. 20 illustrates a hardware implementation for an apparatus adapted that supports an arbitration priority scheme for low latency applications coupled to a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect application processor or other host device with modems and other peripherals. The serial bus may be operated in accordance with specifications and protocols defined by a standards body. For example, the serial bus may be operated in accordance with a standard or protocol such as the I2C and/or I3C protocol that defines timing relationships between signals and transmissions. Certain aspects disclosed herein relate to systems, apparatus, methods and techniques that provide an arbitration scheme that can be used on a serial bus to minimize latency for high priority devices and improve overall link performance

A device coupled to a serial bus, which is operated according to certain bus protocols, can participate in an address arbitration process to gain access to the bus. Different devices may exhibit different delays in responding to a bus master device after winning the arbitration process. The different delays may cause the bus master device to slow its clock signal in order to reliably capture data from one or more data lanes regardless of the speed of response of the winning device.

According to certain aspects disclosed herein, the master device may maintain a table of delay values referenced by enumerated devices coupled to the serial bus. The bus master may delay sampling a response after an arbitration process based on a delay duration defined for the winning device.

### Example Of An Apparatus With A Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

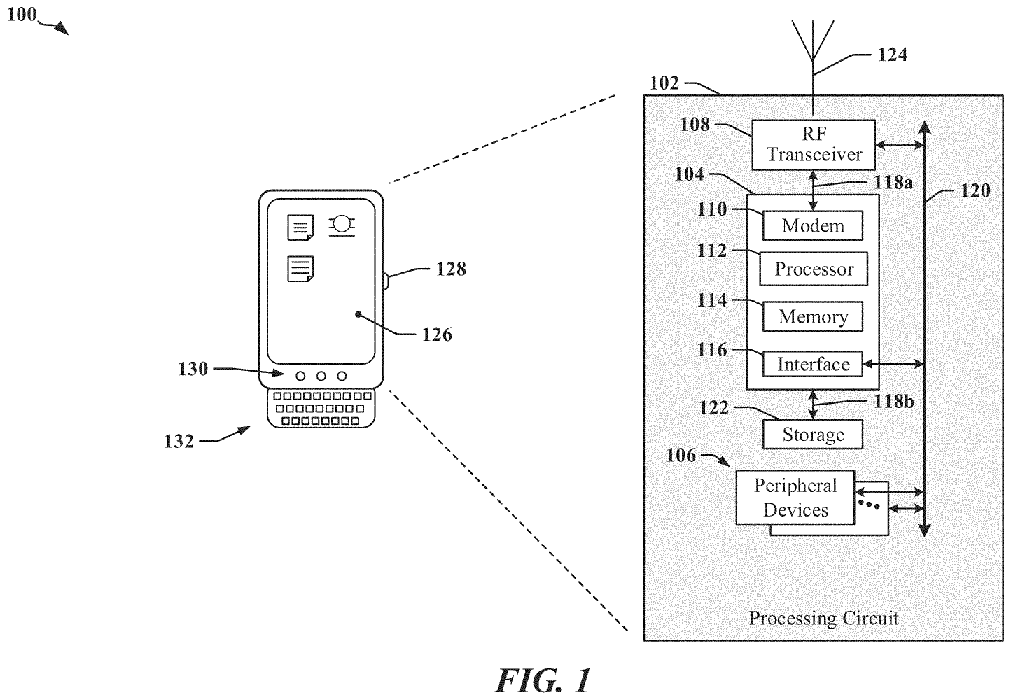

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

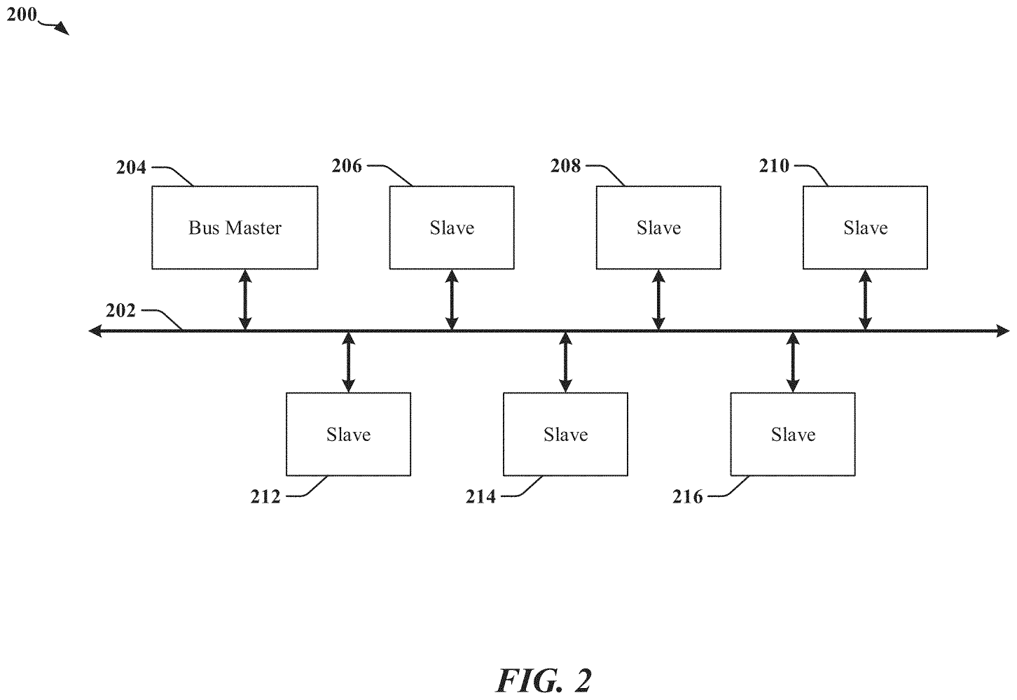

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

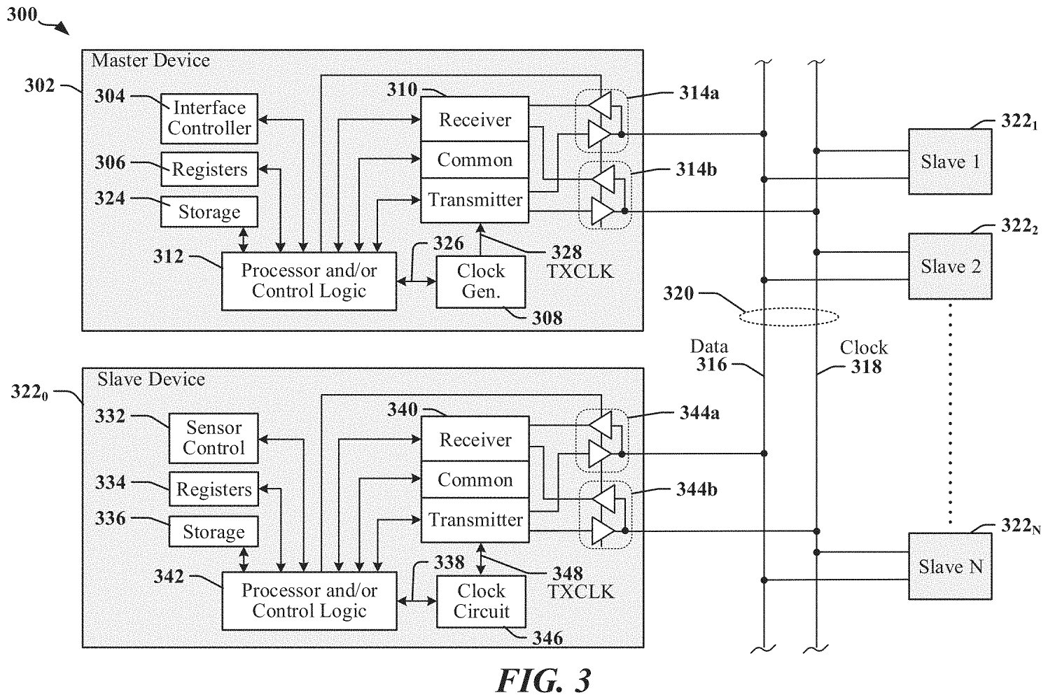

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an applications processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master 302. Certain types of bus can support multiple bus master devices 302.

In one example, a bus master device 302 may include an interface controller 304 that may manage access to the serial bus, configure dynamic addresses for slave devices 322₀-322_{N} and/or generate a clock signal 328 to be transmitted on a clock line 318 of the serial bus 320. The bus master device 302 may include configuration registers 306 or other storage 324, and other control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clocks 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clocks 338 may be used by the control logic 342 and other functions, circuits or modules.

The serial bus 320 may be operated in accordance with RFFE, I2C, I3C, SPMI, or other protocols. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

### Data Transfers Over A Serial Bus

Examples of data transfers including control signaling, command and payload transmissions are provided by way of example. The examples illustrated relate to I2C and I3C communication for convenience. However, certain concepts disclosed herein are applicable to other bus configurations and protocols, including RFFE and SPMI configurations.

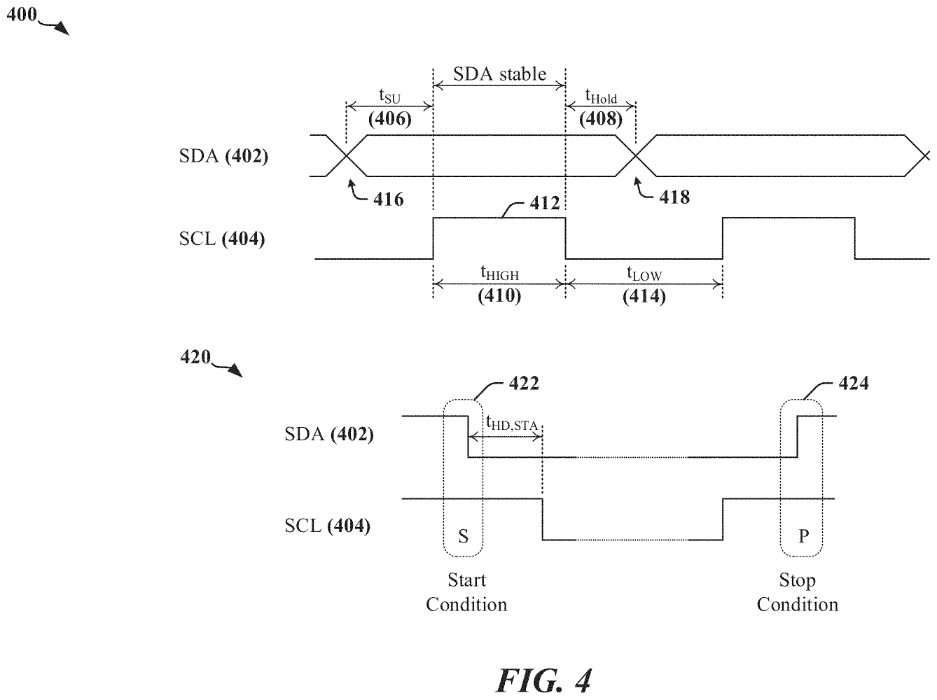

FIG. 4 includes timing diagrams 400 and 420 that illustrate the relationship between the SDA wire 402 and the SCL wire 404 on when the serial bus is operated in an I2C or I3C mode. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

In one example, specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (tsu) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a serial bus. Certain protocols provide for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A start condition 422 is defined to permit the current bus master to signal that data is to be transmitted. The start condition 422 occurs when the SDA wire 402 transitions from high to low while the SCL wire 404 is high. The bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed slave device, if available, responds with an ACK bit. If no slave device responds, the bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a stop condition 424 is transmitted by the master device. The stop condition 424 occurs when the SDA wire 402 transitions from low to high while the SCL wire 404 is high.

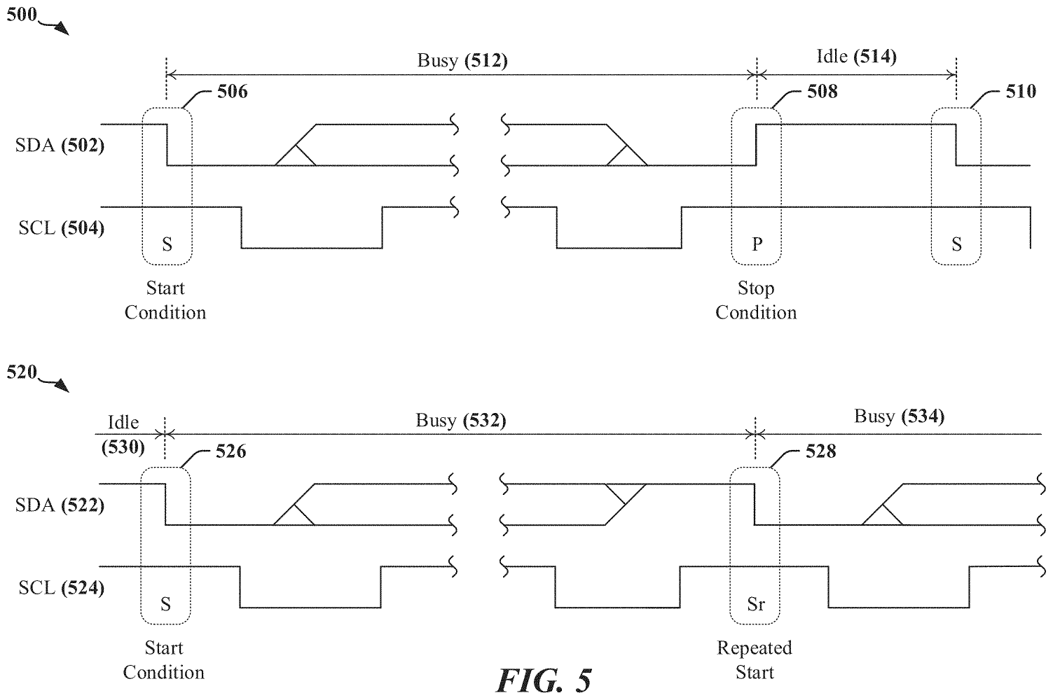

FIG. 5 includes diagrams 500 and 520 that illustrate timing associated with data transmissions on a serial bus operated in accordance with an I2C or I3C protocol. As illustrated in the first diagram 500, an idle period 514 may occur between a stop condition 508 and a consecutive start condition 510. In the illustrated example, the SDA line 502 and SCL line 504 may be held and/or driven to a high voltage state during the idle period 514. This idle period 514 may be prolonged, and may result in reduced data throughput when the serial bus remains idle between the stop condition 508 and the consecutive start condition 510. In operation, a busy period 512 commences when the I2C bus master transmits a first start condition 506, followed by data. The busy period 512 ends when the bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

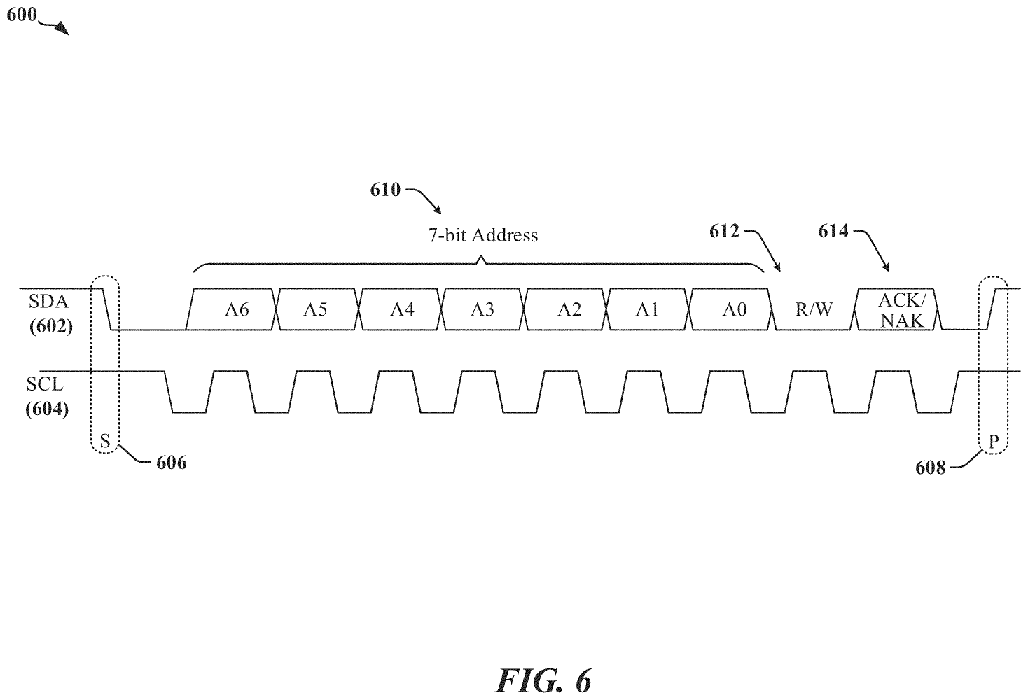

FIG. 6 is a diagram 600 that illustrates an example of the timing associated with an address word sent to a slave device in accordance with certain I2C and/or I3C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the serial bus is in an active state.

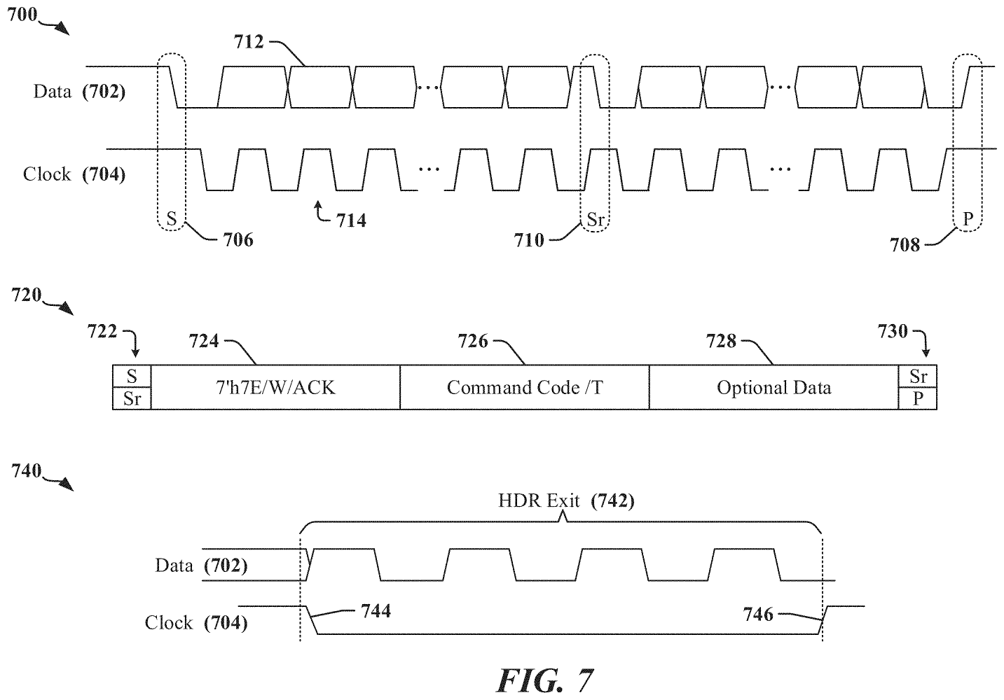

FIG. 7 includes a timing diagram 700 that illustrates signaling on a serial bus when the serial bus is operated in a single data rate (SDR) mode of operation defined by I3C specifications. Data transmitted on a first wire of the serial bus, which may be referred to as the Data wire 702, SDA or SDATA, may be captured using a clock signal transmitted on a second wire of the serial bus, which may be referred to as the Clock wire 704, SCL or SCLOCK. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a START condition 706, a STOP condition 708 or a Repeated Start 710.

On an I3C serial bus, a START condition 706 is defined to permit the current bus master to signal that data is to be transmitted. The START condition 706 occurs when the Data wire 702 transitions from high to low while the Clock wire 704 is high. The bus master may signal completion and/or termination of a transmission using a STOP condition 708. The STOP condition 708 is indicated when the Data wire 702 transitions from low to high while the Clock wire 704 is high. A Repeated Start 710 may be transmitted by a bus master that wishes to initiate a second transmission upon completion of a first transmission. The Repeated Start 710 is transmitted instead of a STOP condition 708, and has the significance of a STOP condition 708 followed immediately by a START condition 706. The Repeated Start 710 occurs when the Data wire 702 transitions from high to low while the Clock wire 704 is high.

The bus master may transmit an initiator 722 that may be a START condition 706 or a Repeated Start 710 prior to transmitting an address of a slave, a command, and/or data. FIG. 7 illustrates a command code transmission 720 by the bus master. The initiator 722 may be followed in transmission by an address header 724 and a command code 726. The command code 726 may, for example, cause the serial bus to transition to a desired mode of operation. In some instances, data 728 may be transmitted. The command code transmission 720 may be followed by a terminator 730 that may be a STOP condition 708 or a Repeated Start 710.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

An I3C bus may be switched between SDR and DDR modes. FIG. 7 includes an example of signaling 740 transmitted on the Data wire 702 and the Clock wire 704 to initiate certain mode changes. The signaling 740 is defined by I3C protocols for use in initiating restart, exit and/or break from I3C HDR modes of communication. The signaling 740 includes an HDR Exit 742 that may be used to cause an HDR break or exit. The HDR Exit 742 commences with a falling edge 744 on the Clock wire 704 and ends with a rising edge 746 on the Clock wire 704. While the Clock wire 704 is in a low signaling state, four pulses are transmitted on the Data wire 702. I2C devices ignore the Data wire 702 when no pulses are provided on the Clock wire 704.

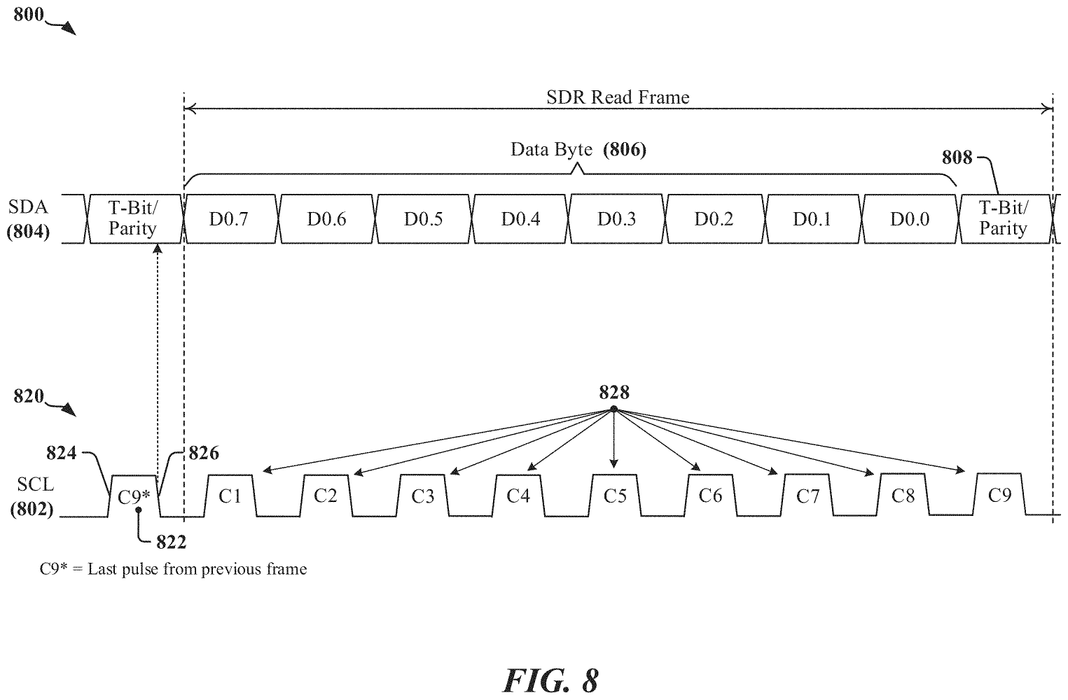

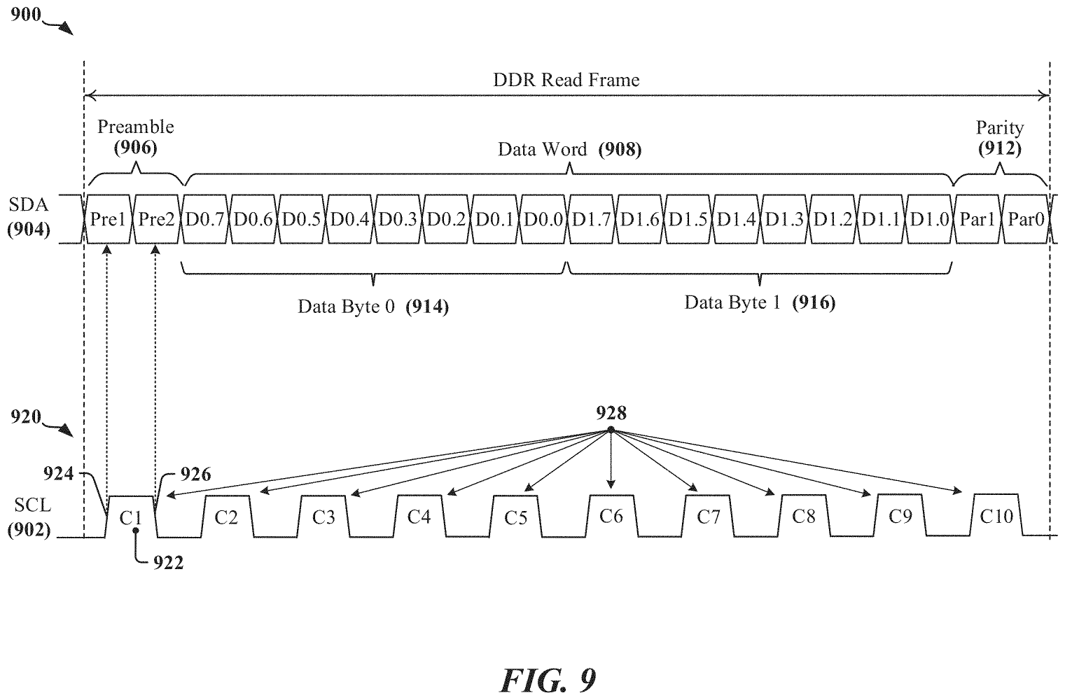

FIGS. 8 and 9 include timing diagrams that illustrate frames 800, 900 transmitted on a serial bus when a bus master device is reading from a slave device. The serial bus has a clock wire (SCL 802, 902) and a Data wire (SDA 804, 904). A clock signal 820, 920 transmitted on SCL 802, 902 provides timing may be usable when the serial bus is operated in an I3C single data rate (SDR) mode and in an I3C high data rate (HDR) double data rate (DDR) mode. The clock signal includes pulses 822, 828, 922, 928 that are defined by a rising edge 824, 924 and a falling edge 826, 926. A bus master device transmits the clock signal on the SCL 802, 902 regardless of the direction of flow of data over the serial bus.

FIG. 8 illustrates a frame 800 transmitted while the serial bus is operated in the I3C

SDR mode. A single byte of data 806 is transmitted in each frame 800. The data signal transmitted on SDA 804 is expected to be stable for the duration of the high state of the pulses 828 in the clock signal 820 and, in one example, the state of SDA 804 is sampled on the falling edges of the clock pulses 828. Each byte of data 806 is followed by a bit 808 that can serve as a parity bit or a transition bit (T-Bit).

FIG. 9 illustrates a frame 900 transmitted while the serial bus is operated in the HDR-DDR mode. In the HDR-DDR mode, data is transferred at both the rising edge 924 and the falling edge 926 of a pulse 922 in the clock signal 920. A receiver samples or captures one bit of data on SDA 904 at each edge of the pulses 928 in the clock signal 920. A 2-byte data word 908 is transmitted in each frame 900 in the HDR-DDR mode. A data word 908 generally includes 16 payload bits, organized as two 8-bit bytes 914, 916 and the data word 908 is preceded by a two-bit preamble 906 and followed by two parity bits 912. The 20 bits in the frame 900 can be transferred on the edges of 10 clock pulses. The integrity of the transmission may be protected by the transmission of the parity bits 912.

### High-Priority/Low-Latency Example: Virtual GPIO

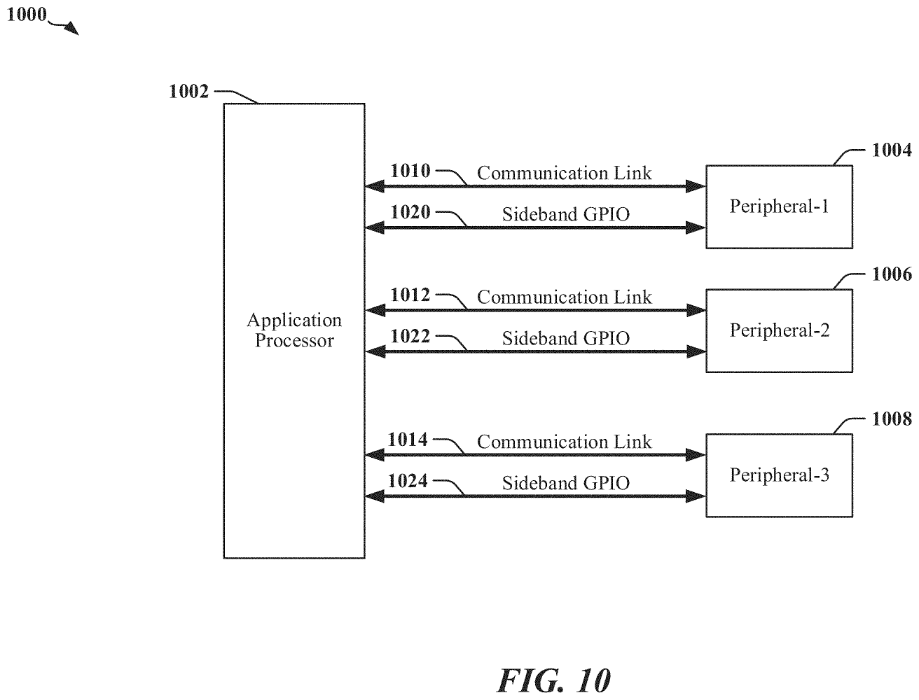

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 10 illustrates an apparatus 1000 that includes an Application Processor 1002 and multiple peripheral devices 1004, 1006, 1008. In the example, each peripheral device 1004, 1006, 1008 communicates with the Application Processor 1002 over a respective communication link 1010, 1012, 1014 operated in accordance with mutually different protocols. Communication between the Application Processor 1002 and each peripheral device 1004, 1006, 1008 may involve additional wires that carry control or command signals between the Application Processor 1002 and the peripheral devices 1004, 1006, 1008. These additional wires may be referred to as sideband general purpose input/output (sideband GPIO 1020, 1022, 1024), and in some instances the number of connections needed for sideband GPIO 1020, 1022, 1024 can exceed the number of connections used for a communication link 1010, 1012, 1014.

GPIO provides generic pins/connections that may be customized for particular applications. For example, a GPIO pin may be programmable to function as an output, input pin or a bidirectional pin, in accordance with application needs. In one example, the Application Processor 1002 may assign and/or configure a number of GPIO pins to conduct handshake signaling or inter-processor communication (IPC) with a peripheral device 1004, 1006, 1008 such as a modem. When handshake signaling is used, sideband signaling may be symmetric, where signaling is transmitted and received by the Application Processor 1002 and a peripheral device 1004, 1006, 1008. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, packetized, serialized and transmitted over a communication link In one example, captured GPIO may be transmitted over an I3C bus using common command codes to indicate that an I3C transaction includes packetized GPIO information and/or a destination for GPIO information.

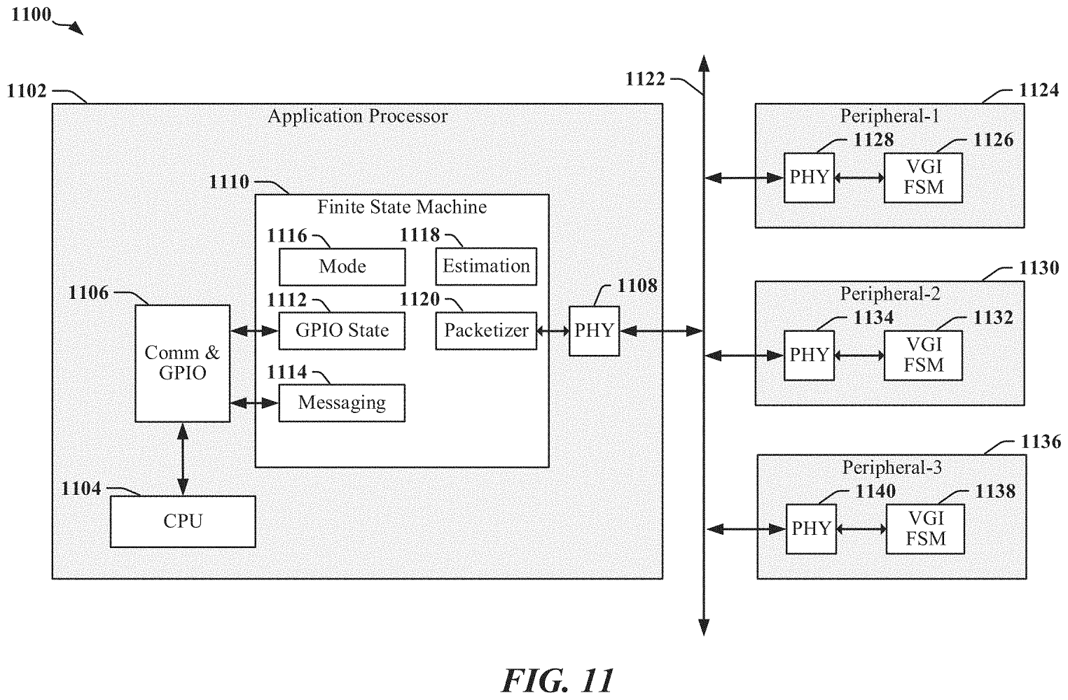

FIG. 11 illustrates an apparatus 1100 that is adapted to support Virtual GPIO (VGI) in accordance with certain aspects disclosed herein. VGI circuits and techniques can reduce the number of physical pins and connections used to connect an Application Processor 1102 with one or more peripheral devices 1124, 1130, 1136. A finite state machine (VGI FSM 1110) may be configured to manage and/or implement virtualization of GPIO state for transmission in virtual GPIO messages over a communication link 1122. In one example, virtual GPIO messages may be transmitted in packets over a communication link 1122 that includes a multi-wire bus, such as a serial bus. When the communication link 1122 is provided as a serial bus, the receiving peripheral device 1124, 1130, 1136 may deserialize received packets and may extract virtual GPIO messages in packets received from the Application Processor 1102. A finite state machine (VGI FSM 1126, 1132, 1138) in the peripheral device 1124, 1130, 1136 may convert the virtual GPIO messages to physical GPIO state of internal GPIO pins.

In another example, the communication link 1122 may be a provided by a radio frequency transceiver that supports communication using, for example, a Bluetooth protocol, a WLAN protocol, a cellular wide area network, and/or another communication protocol. Virtual GPIO state may be transmitted in packets, frames, subframes, transactions, or other data structures over the communication link 1122, and the receiving peripheral device 1124, 1130, 1136 may extract, deserialize and otherwise process received signaling to obtain the virtual GPIO state. Upon receipt of virtual GPIO messages, the VGI FSM 1126, 1132, 1138 or another component of the receiving device may interrupt its host processor to indicate receipt of the messages and/or any changes in physical GPIO state.

In an example in which the communication link 1122 is implemented as a serial bus, virtual GPIO messages may be transmitted as payload data in transactions configured for an I2C, I3C, or another standardized serial interface. In the illustrated example, VGI techniques may be employed to accommodate I/O bridging between an Application Processor 1102 and one or more peripheral devices 1124, 1130, 1136. The Application Processor 1102 may be provided in an ASIC, SoC, or another type of IC device. The Application Processor 1102 includes a processor (central processing unit or CPU 1104) that generates events and virtual GPIO messages associated with one or more communication channels 1106. Virtual GPIO messages produced by the communication channels 1106 may be monitored by respective monitoring circuits 1112, 1114 in a VGI FSM 1126, 1132, 1138. In some examples, a GPIO monitoring circuit 1112 may be adapted to produce virtual GPIO messages representative of the state of physical GPIO state and/or changes in the physical GPIO state. In some examples, other circuits are provided to produce the virtual GPIO messages representative of the physical GPIO state and/or changes in physical GPIO state.

An estimation circuit 1118 may be configured to estimate latency information for the virtual GPIO messages, and may select a protocol, and/or a mode of communication for the communication link 1122 that optimizes the latency for encoding and transmitting the virtual GPIO messages. The estimation circuit 1118 may maintain protocol and mode information 1116 that characterizes certain aspects of the communication link 1122 to be considered when selecting the protocol, and/or a mode of communication. The estimation circuit 1118 may be further configured to select a packet type for encoding and transmitting the virtual GPIO messages. The estimation circuit 1118 may provide configuration information used by a packetizer 1120 to encode physical GPIO state. In one example, the configuration information is provided as a command that may be encapsulated in a packet such that the type of packet can be determined at a receiver. The configuration information, which may be a command, may also be provided to physical layer circuits (PHY 1108). The PHY 1108 may use the configuration information to select a protocol and/or mode of communication for transmitting the associated packet. The PHY 1108 may then generate the appropriate signaling to transmit the packet.

The peripheral device 1124, 1130, 1136 may include a VGI FSM 1126, 1132, 1138 that is configured to process data packets received from the communication link 1122. The VGI FSM 1126, 1132, 1138 at the peripheral device 1124, 1130, 1136 may extract messages and may map bit positions in virtual GPIO messages onto physical GPIO pins in the peripheral device 1124, 1130, 1136. In certain embodiments, the communication link 1122 is bidirectional, and both the Application Processor 1102 and a peripheral device 1124, 1130, 1136 may operate as both transmitter and receiver.

The PHY 1108 in the Application Processor 1102 and a corresponding PHY 1128, 1134, 1140 in the peripheral device 1124, 1130, 1136 may be configured to establish and operate the communication link 1122. Each PHY 1108, 1128, 1134, 1140 may be coupled to, or include a transceiver 108 (see FIG. 1). In some examples, the PHY 1108, 1128, 1134, 1140 may support a two-wire interface such as an I2C and/or I3C interface at the Application Processor 1102 and peripheral device 1124, 1130, 1136, respectively, and virtual GPIO messages may be encapsulated into a packet transmitted over the communication link 1122.

VGI tunneling, as described herein, can be implemented using existing or available protocols configured for operating the communication link 1122, and without the full complement of physical GPIO pins. VGI FSMs 1110, 1126, 1132, 1138 may virtualize GPIO state without intervention of a processor in the Application Processor 1102 and/or a processor in the peripheral device 1124, 1130, 1136. The use of VGI can reduce pin count, power consumption, and latency associated with the communication link 1122.

At a receiving device, virtual GPIO messages are decoded to produce physical GPIO state. Certain characteristics of the physical GPIO pins may be configured using the virtual GPIO messages. For example, slew rate, polarity, drive strength, and other related parameters and attributes of the physical GPIO pins may be configured using the virtual GPIO messages. Configuration parameters used to configure the physical GPIO pins may be stored in configuration registers associated with corresponding GPIO pins. These configuration parameters can be addressed using a proprietary or conventional protocol such as I2C and/or I3C protocols. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of virtual GPIO messages, whereby virtual GPIO messages, application messages, or both can be sent as a serial data stream over a communication link 1122. In one example, a serial data stream may be packetized for transmission over an I2C and/or I3C bus in a transaction, which may include a sequence of frames. The presence of virtual GPIO data in an I2C/I3C frame may be signaled using a special command code to identify the frame as a virtual GPIO frame. Virtual GPIO frames may be transmitted as broadcast frames or addressed frames in accordance with an I2C or I3C protocol. The VGI interface may also be referred to as a VGI messaging interface or VGMI.

Certain aspects disclosed herein can enable, support or optimize an I3C serial bus used for exchanging VGI messages between two or more devices. An interface that communicates VGI messages over I3C may be implemented as a logical layer that manages the exchange of GPIO state information. The use of an I3C interface to exchange VGI messages can leverage the advantages derived from certain I3C features including variable length messaging and flow control in a multi-slave device environment.

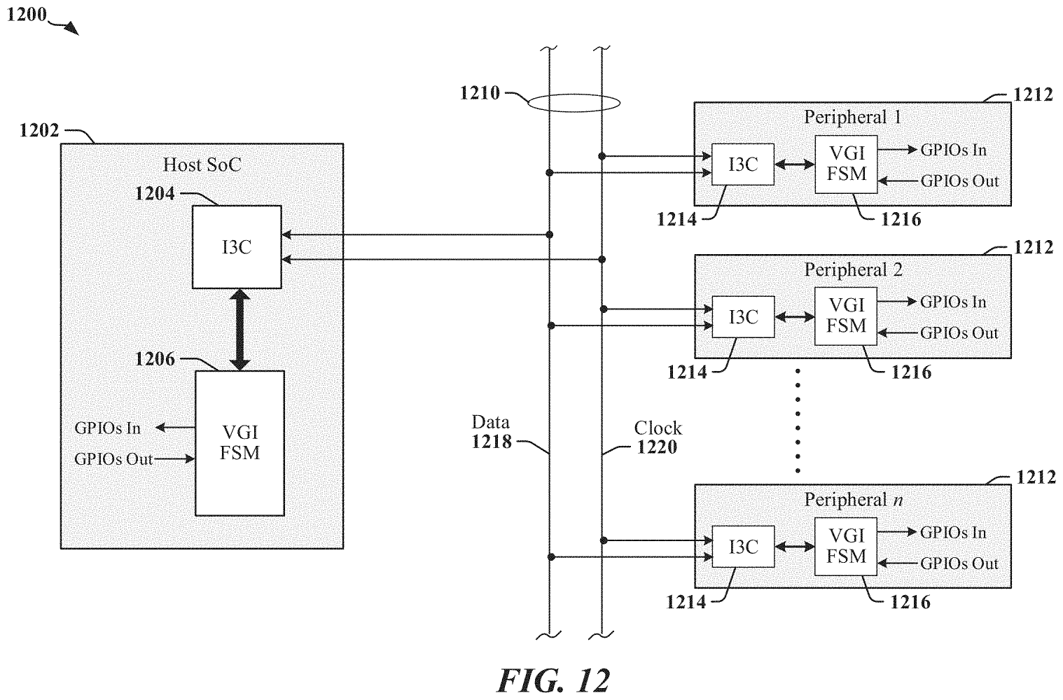

FIG. 12 illustrates an example of an apparatus 1200 that uses an I3C bus that couples multiple devices 1202, 1212 and that can carry VGI messages between two or more devices 1202, 1212. The apparatus may include a host SoC 1202 and a number of peripheral devices 1212. The host SoC 1202 may include a virtual GPIO finite state machine (VGI FSM 1206) and an I3C interface 1204, where the I3C interface 1204 cooperates with corresponding I3C interfaces 1214 in the peripheral devices 1212 to provide a communication link between the host SoC 1202 and the peripheral devices 1212. Each peripheral device 1212 includes a VGI FSM 1216. In the illustrated example, communications between the SoC 1202 and a peripheral device 1212 may be serialized and transmitted over a multi-wire serial bus 1210 in accordance with an I3C protocol. In other examples, the host SoC 1202 may include other types of interface, including I2C and/or RFFE interfaces. In other examples, the host SoC 1202 may include a configurable interface that may be employed to communicate using I2C, I3C, RFFE and/or another suitable protocol. In some examples, a multi-wire serial bus 1210, such as an I2C or I3C bus, may transmit a data signal over a data wire 1218 and a clock signal over a clock wire 1220.

Virtual GPIO may be transmitted in high-priority, low-latency messages. Bus latency may include the time required to terminate a transaction in process on the serial bus, bus turnaround (between transmit mode and receive mode), bus arbitration and/or command transmissions specified by protocol. Bus latency can affect the ability of a serial bus to handle high-priority, real-time and/or other time-constrained messages. Low-latency messages, or messages requiring low bus latency, may carry information related to sensor status, device-generated real-time events and virtualized GPIO. In one example, bus latency may be measured as the time elapsed between a message becoming available for transmission and the delivery of the message or, in some instances, commencement of transmission of the message. Other measures of bus latency may be employed or available to a system designer. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

### In-Band Interrupts and Address Arbitration on a Serial Bus

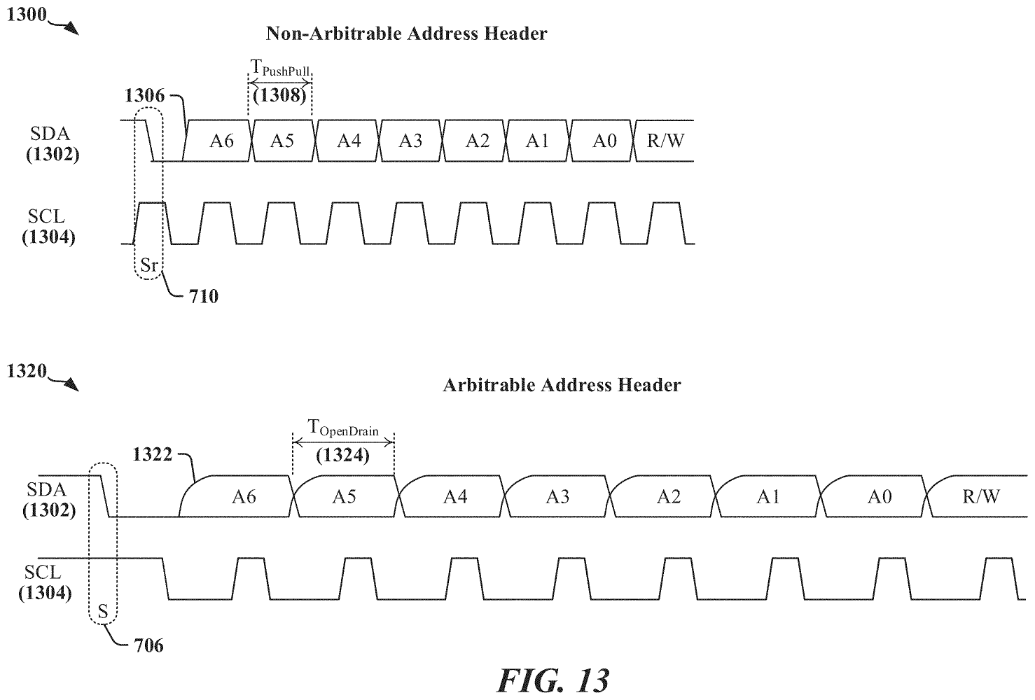

In-band interrupts may be used to gain access to an I3C bus in order to transit high-priority and/or low-latency messages, including VGI messages for example. A device other than the current bus master may assert an in-band interrupt during transmission of certain address fields to initiate an arbitration process that enables the asserting device to gain access to a serial bus. The serial bus may be operated in a mode in which data is transmitted on a data line in accordance with timing provided by a clock signal transmitted on a clock line. FIG. 13 illustrates a non-arbitrable address header 1300 and an arbitrable address header 1320 that may be transmitted on the SDA line 1302 of the serial bus in accordance with I3C protocols. I3C protocols provide for different types of request to be transmitted using an I3C arbitrable address header. I3C arbitrable address headers 1320 can be transmitted after a START condition 706. An address header 724 transmitted after a Repeated Start 710 is not arbitrable. A device may use an I3C arbitrable address header to assert an In-Band Interrupt, make a secondary master request, or indicate a hot-join request.

A non-arbitrable address header 1300 is transmitted using push-pull drivers, while open-drain drivers are enabled during transmission of an arbitrable address header 1320. Rising edges 1306 in a push-pull transmission provide a shorter bit interval 1308 than the bit interval 1324 available during an open-drain transmission, due to the slow rise time of the pulled-up edges 1322 in a non-arbitrable address header 1300. In FIG. 13, the bit intervals 1308, 1324 are not depicted on a common scale.

A clock signal transmitted on the SCL line 1304 provides timing information that is used by a slave device to control transmission of bits on the SDA line 1302, where the clock signal may be used by a receiving device for sampling and/or capturing bits of data transmitted on the SDA line 1302. A bus master device may read one or more registers on a slave device or secondary master device that wins arbitration. In conventional systems, the bus master device may provide clock pulses in a clock signal that have a period sufficient to successfully read the slowest possible device coupled to the serial bus. Each slave device has different operating characteristics and limitations that affect the response time of the slave device. In one example, the response time of a slave device may be affected by the physical distance between the slave device and the bus master device. In another example, the response time of a slave device may be affected by the processing capabilities of the slave device, where a slower controller, state machine or other processor in the slave device may delay responses transmitted by the slave device during in-band interrupt handling and/or processing.

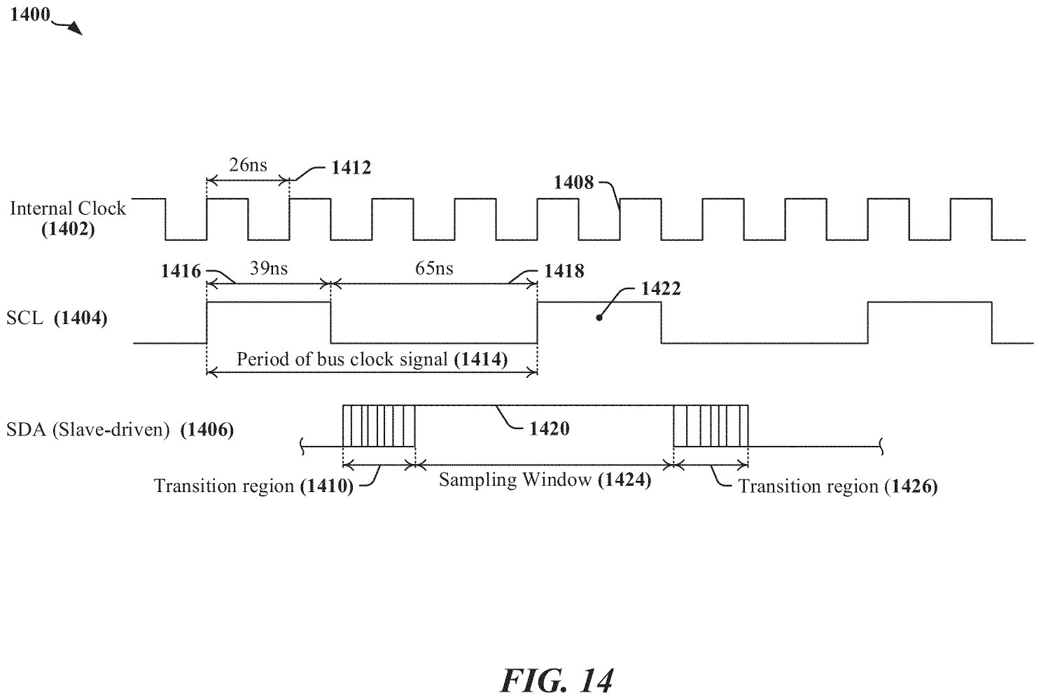

FIG. 14 is a timing diagram 1400 that illustrates an example of variability of response in the apparatus 300 of FIG. 3 that includes multiple slave devices 322₀-322_{N} coupled to a master device 302 through a serial bus 320. In this example, the serial bus 320 is operated in accordance with an I3C protocol. The bus master device 302 transmits a bus clock signal over SCL 1404 based on timing of an internal clock signal 1402. In the illustrated example, the internal clock signal 1402 has a 26 ns period 1412. The period 1414 of the bus clock signal is 104 ns and includes a high duration 1416 of 39 ns and a low duration 1418 that is 65 ns.

In the example, one of the slave devices 322₀-322_{N}, having won the arbitration process, transmits a bit value that causes SDA 1406 to transition to a high state 1420. A bus master device 302 operated in accordance with I3C protocols is configured to capture the state of SDA 1406 during a pulse 1422 on SCL 1404. The slave device 322₀-322 may have or exhibit different response times and/or latencies with respect to a nominally performing device, and the transition to the high state 1420 may occur within a transition interval 1410. The transition interval 1410 and a second transition interval 1426 after termination of the pulse 1422 may determine a sampling window 1424 in which the value transmitted by the slave device 322₀-322 can be captured. In some instances, the duration of the transition intervals 1410 may be sufficient to introduce unreliability in the reading of the winning device by the bus master device 302. In one example, unreliability may occur when the edge 1408 in its internal clock signal 1402 used by the bus master device 302 to capture the state of SDA 1406 occurs in one of the transition intervals 1410, 1426. In conventional systems, response times to in-band interrupts can vary greatly between slave devices 322₀-322, and the resultant large transition intervals 1410, 1426 forces the use of low-frequency bus clock signals.

An apparatus 300 adapted in accordance with certain aspects disclosed herein may delay the point of capture and/or may delay a received data signal received based on the operating characteristics of the slave device 322₀-322_{N}, that won the arbitration process. The delay for each slave device 322₀-322_{N} may be selected to maximize, or otherwise optimize an effective sampling window.

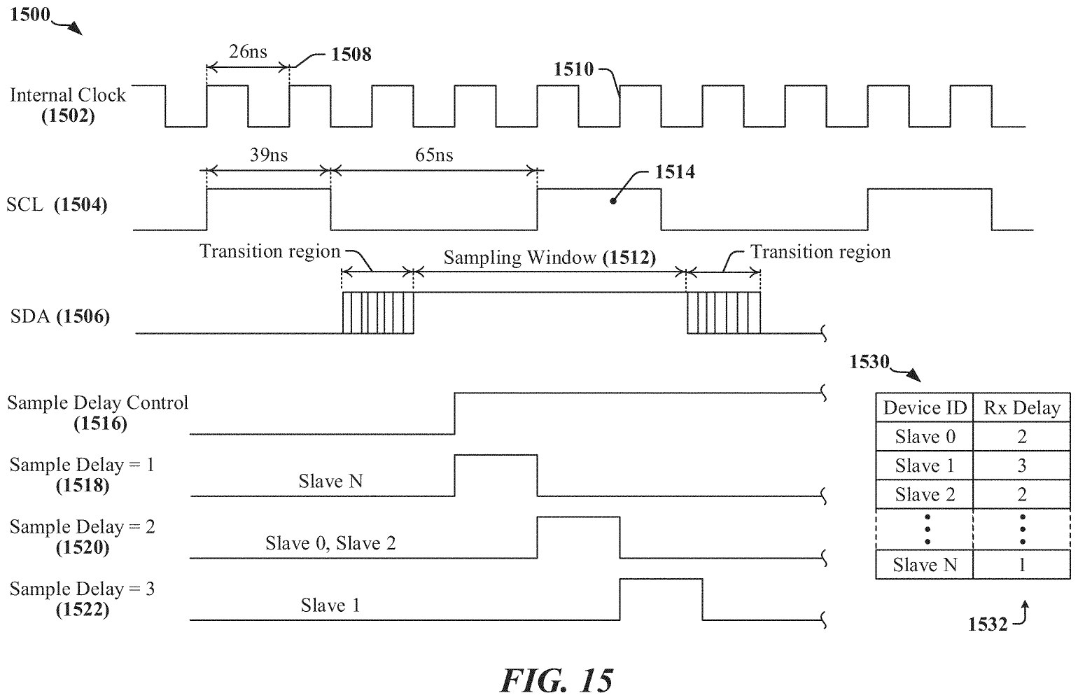

FIG. 15 is a timing diagram 1500 that illustrates a device-specific configuration of a sampling circuit in a master device 302 that reads or interrogates the slave device 322₀-322_{N} that won the arbitration process. The bus master device 302 transmits a bus clock signal over SCL 1504 based on timing of an internal clock signal 1502. In the illustrated example, the internal clock signal 1502 has a 26 ns period 1508. In some implementations, the internal clock signal 1502 may have a higher or lower frequency. In the example, the period of the bus clock signal is 104 ns and includes a high duration of 39 ns and a low duration that is 65 ns.

A bus master device 302 adapted in accordance with certain aspects disclosed herein may maintain a table 1530 that relates each of the slave devices 322₀-322_{N} to a delay value that is based on certain operating characteristics of the slave device 322₀-322_{N}. The delay value may indicate a number of cycles of the internal clock signal 1502 that can be used to identify a sampling point 1510 with respect to a reference sampling point or earliest sampling point. The delay values may be used to provide an optimal sampling point for each of the slave devices 322₀-322_{N}. The provision of an optimal sampling point may maximize the sampling window 1512 for each slave device 322₀-322_{N}. A default sampling point may be assigned for any of the slave devices 322₀-322_{N} for which the optimal sampling point 1510 is not known or determinable. The default sampling point may be selected to fall within a common sampling window 1512. The delay values may be used to offset different response times and/or latencies of the slave device 322₀-322_{N}.

In the illustrated example, the slowest device (Slave 1 322₁) is associated with a 3-period delay value in the table 1530, the fastest device (Slave N 322_{N}) is associated with a 1-period delay value in the table 1530, and two devices (Slave 0 322₀ and Slave 2 322₂) are associated with a 2-period delay value in the table 1530. In one example, the delay values 1532 may enumerate a number of edges, pulses or cycles in the internal clock signal 1502 to be added to an earliest sampling point. In another example, delay values may be stored in the table 1530 that indicate a number of cycles by which the data signal received on SDA 1506 is delayed before sampling.

In one example, the delay values 1532 may be used to control timing of sampling pulses 1518, 1520, 1522 for receiving data from a winning device after an in-band interrupt. A default pulse 1514 may be provided when the table 1530 is not initiated, or no entry for the winning device appears in the table 1530. A control signal 1516 may determine whether the delay values 1532 are to be referenced when generating sampling pulses 1514, 1518, 1520, 1522. In other examples, the delay values 1532 may be used to delay a data signal received from SDA 1506 such that positioning of a default sampling pulse 1514 within the sampling window 1512 corresponding to the winning device is optimized.

The values that populate the table 1530 may be stored or otherwise provided during device manufacture, system integration, and/or initial system configuration. In one example, delay values may be provided in specifications provided by manufacturers of the slave devices 322₀-322_{N}. In another example, a system designer may determine the delay values from specifications provided by manufacturers of the slave devices 322₀-322_{N}, and from circuit design and/or chip placement plans. In another example, the delay values may be learnt from operation or calibration of the apparatus 300.

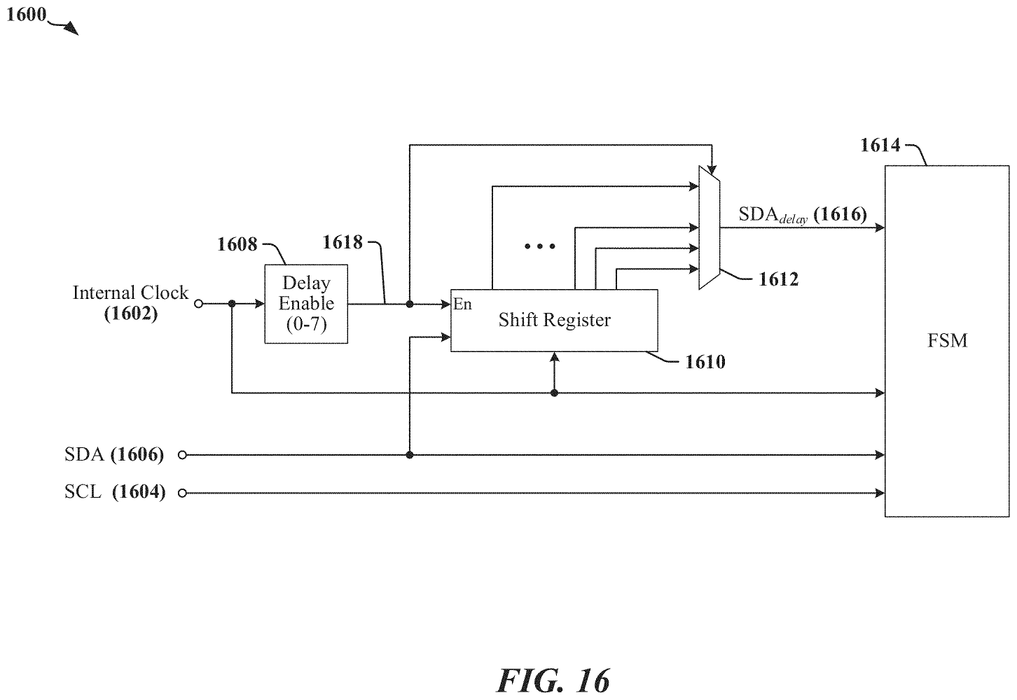

FIG. 16 illustrates a receiving circuit 1600 that can be adapted to operate in accordance with certain aspects of the invention. The receiving circuit 1600 may include a finite state machine 1614 or another type of processing device configured process a data signal received from SDA 1606. The finite state machine 1614 may receive and/or generate the clock signal transmitted on SCL 1604, and may receive and/or generate an internal clock signal 1602. In the illustrated example, the data signal received from SDA 1606 may be provided as an input to a shift register 1610. The shift register 1610 may be clocked by the internal clock signal 1602 and may operate as a delay line, multiple versions of the data signal, each version characterized by a different size of delay. The shift register 1610 may be enabled by logic 1608 that provides one or more signals 1618 responsive to the table 1530, including a signal that enables the shift register 1610 and a signal that configures a multiplexer 1612 to select a desired shifted version of the data signal. The multiplexer 1612 may provide a delayed data signal 1616 as an output, which may be provided to the finite state machine 1614, which may sample the delayed data signal 1616 or the original data signal as defined by system configuration or by an application.

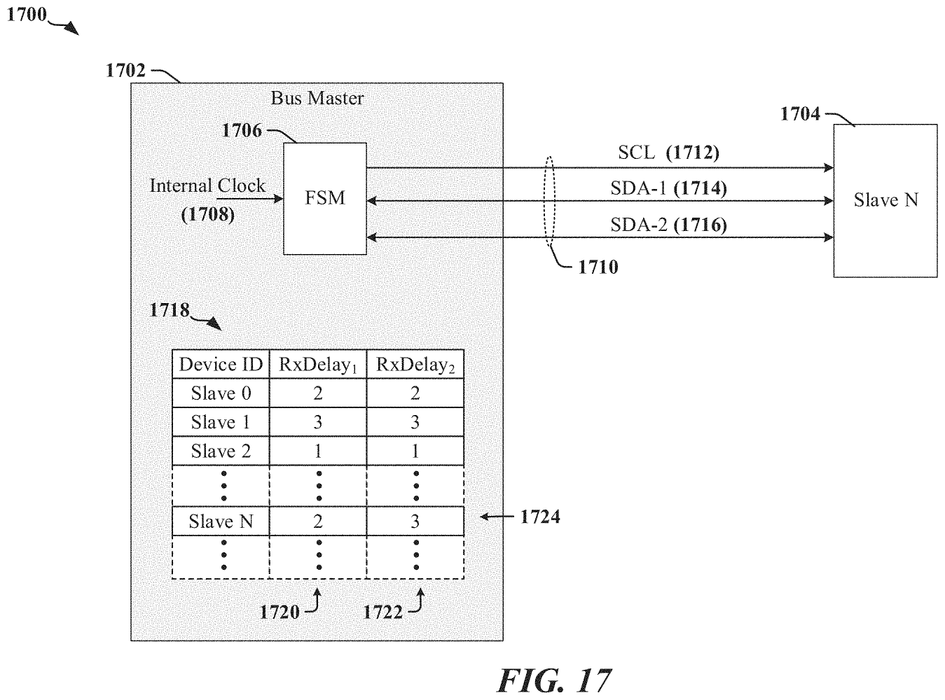

FIG. 17 illustrates an apparatus 1700 that may be adapted in accordance with certain aspects disclosed herein. The apparatus 1700 includes a bus master device 1702 and multiple slave devices coupled by a multidrop serial bus 1710 that has a clock line 1712 and multiple data lanes, including SDA-1 1714 and SDA-2 1716. In one example, the serial bus 1710 is operated in accordance with an I3C protocol. Only the Nth slave device 1704 is shown in FIG. 17. The bus master device 1702 may include a finite state machine 1706 that is configured to sample SDA-1 1714 and/or SDA-2 1716 based on timing information provided by an internal clock signal 1708 and delay values 1720, 1722 in a table 1718.

In some implementations, the table 1718 maintains delay values 1720, 1722 for SDA-1 1714 and SDA-2 1716 respectively, where the delay values 1720, 1722 may be paired and associated with enumerated devices coupled to the serial bus. The delay values 1724 associated with the winning device determined in an arbitration, which may be the Nth slave device 1704 for this example, are used to control timing of sampling the response from the Nth slave device 1704. The delay values 1724 can ensure that valid sampling window is provided. As illustrated in the example, the delay values 1720, 1722 associated with different data lanes of the serial bus 1710 can be the same or different for SDA-1 1714 and SDA-2 1716.

### Examples of Processing Circuits and Methods

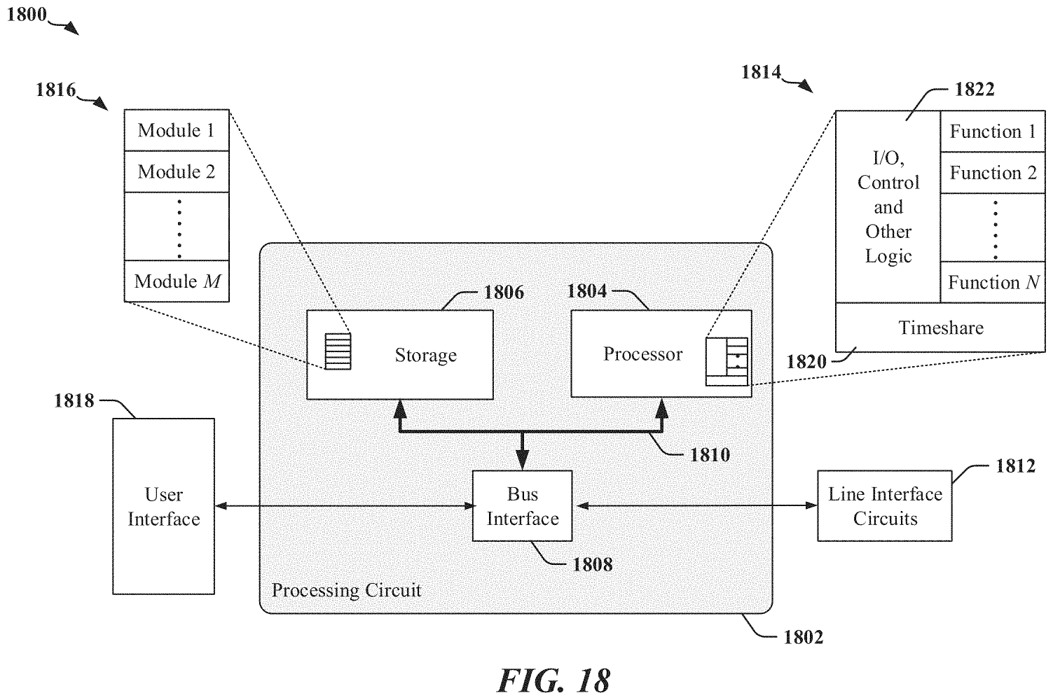

FIG. 18 is a diagram illustrating an example of a hardware implementation for an apparatus 1800 employing a processing circuit 1802 that may be configured to perform one or more functions disclosed herein. In accordance with various aspects of the disclosure, an element, or any portion of an element, or any combination of elements as disclosed herein may be implemented using the processing circuit 1802. The processing circuit 1802 may include one or more processors 1804 that are controlled by some combination of hardware and software modules. Examples of processors 1804 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1804 may include specialized processors that perform specific functions, and that may be configured, augmented or controlled by one of the software modules 1816. The one or more processors 1804 may be configured through a combination of software modules 1816 loaded during initialization, and further configured by loading or unloading one or more software modules 1816 during operation. In various examples, the processing circuit 1802 may be implemented using a state machine, sequencer, signal processor and/or general-purpose processor, or a combination of such devices and circuits.

In the illustrated example, the processing circuit 1802 may be implemented with a bus architecture, represented generally by the bus 1810. The bus 1810 may include any number of interconnecting buses and bridges depending on the specific application of the processing circuit 1802 and the overall design constraints. The bus 1810 links together various circuits including the one or more processors 1804, and storage 1806. Storage 1806 may include memory devices and mass storage devices, and may be referred to herein as computer-readable media and/or processor-readable media. The bus 1810 may also link various other circuits such as timing sources, timers, peripherals, voltage regulators, and power management circuits. A bus interface 1808 may provide an interface between the bus 1810 and one or more transceivers 1812. A transceiver 1812 may be provided for each networking technology supported by the processing circuit. In some instances, multiple networking technologies may share some or all of the circuitry or processing modules found in a transceiver 1812. Each transceiver 1812 provides a means for communicating with various other apparatus over a transmission medium. Depending upon the nature of the apparatus 1800, a user interface 1818 (e.g., keypad, display, speaker, microphone, joystick) may also be provided, and may be communicatively coupled to the bus 1810 directly or through the bus interface 1808.

A processor 1804 may be responsible for managing the bus 1810 and for general processing that may include the execution of software stored in a computer-readable medium that may include the storage 1806. In this respect, the processing circuit 1802, including the processor 1804, may be used to implement any of the methods, functions and techniques disclosed herein. The storage 1806 may be used for storing data that is manipulated by the processor 1804 when executing software, and the software may be configured to implement any one of the methods disclosed herein.

One or more processors 1804 in the processing circuit 1802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1806 or in an external computer-readable medium. The external computer-readable medium and/or storage 1806 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1806 may also include, by way of example, a carrier wave, a transmission line, and any other suitable medium for transmitting software and/or instructions that may be accessed and read by a computer. Computer-readable medium and/or the storage 1806 may reside in the processing circuit 1802, in the processor 1804, external to the processing circuit 1802, or be distributed across multiple entities including the processing circuit 1802. The computer-readable medium and/or storage 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1806 may maintain software maintained and/or organized in loadable code segments, modules, applications, programs, etc., which may be referred to herein as software modules 1816. Each of the software modules 1816 may include instructions and data that, when installed or loaded on the processing circuit 1802 and executed by the one or more processors 1804, contribute to a run-time image 1814 that controls the operation of the one or more processors 1804. When executed, certain instructions may cause the processing circuit 1802 to perform functions in accordance with certain methods, algorithms and processes described herein.

Some of the software modules 1816 may be loaded during initialization of the processing circuit 1802, and these software modules 1816 may configure the processing circuit 1802 to enable performance of the various functions disclosed herein. For example, some software modules 1816 may configure internal devices and/or logic circuits 1822 of the processor 1804, and may manage access to external devices such as the transceiver 1812, the bus interface 1808, the user interface 1818, timers, mathematical coprocessors, and so on. The software modules 1816 may include a control program and/or an operating system that interacts with interrupt handlers and device drivers, and that controls access to various resources provided by the processing circuit 1802. The resources may include memory, processing time, access to the transceiver 1812, the user interface 1818, and so on.

One or more processors 1804 of the processing circuit 1802 may be multifunctional, whereby some of the software modules 1816 are loaded and configured to perform different functions or different instances of the same function. The one or more processors 1804 may additionally be adapted to manage background tasks initiated in response to inputs from the user interface 1818, the transceiver 1812, and device drivers, for example. To support the performance of multiple functions, the one or more processors 1804 may be configured to provide a multitasking environment, whereby each of a plurality of functions is implemented as a set of tasks serviced by the one or more processors 1804 as needed or desired. In one example, the multitasking environment may be implemented using a timesharing program 1820 that passes control of a processor 1804 between different tasks, whereby each task returns control of the one or more processors 1804 to the timesharing program 1820 upon completion of any outstanding operations and/or in response to an input such as an interrupt. When a task has control of the one or more processors 1804, the processing circuit is effectively specialized for the purposes addressed by the function associated with the controlling task. The timesharing program 1820 may include an operating system, a main loop that transfers control on a round-robin basis, a function that allocates control of the one or more processors 1804 in accordance with a prioritization of the functions, and/or an interrupt driven main loop that responds to external events by providing control of the one or more processors 1804 to a handling function.

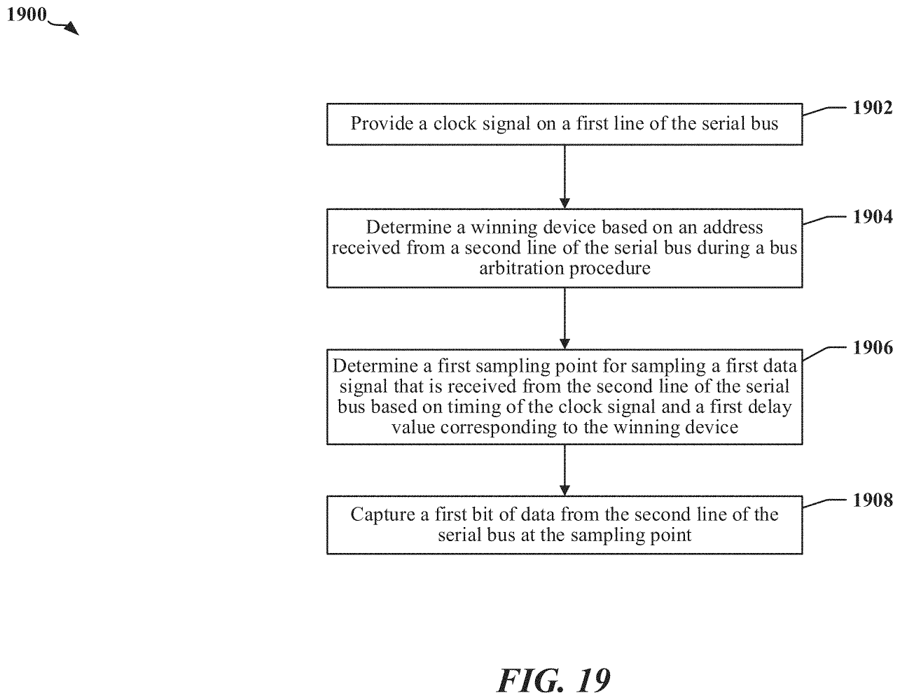

FIG. 19 is a flowchart 1900 illustrating a process that may be performed at a master device coupled to a serial bus. The serial bus may be operated in accordance with one or more I3C protocols. The process may relate to an arbitration process used to access to a serial bus. At block 1902, the master device may provide a clock signal on a first line of the serial bus. At block 1904, the master device may determine a winning device based on an address received from a second line of the serial bus during a bus arbitration procedure. At block 1906, the master device may determine a first sampling point for sampling a first data signal that is received from the second line of the serial bus based on timing of the clock signal and a first delay value corresponding to the winning device. At block 1908, the master device may capture a first bit of data from the second line of the serial bus at the sampling point.

In certain examples, the master device may determine a second sampling point for sampling a second data signal that is received from a third line of the serial bus based on timing of the clock signal and a second delay value corresponding to the winning device, and capture a second bit of data from the third line of the serial bus at the second sampling point.

In some instances, the first sampling point is coincident with the second sampling point.

In other instances, a delay is provided between the first sampling point and the second sampling point.

In one example, the master device may delay the first data signal using a delay line, and capture the first bit of data from an output of the delay line that is selected using the first delay value.

In some instances, the first delay value is expressed as a number of cycles of a timing signal used to generate the clock signal. In other instances, the first delay value is expressed as a number of edges in a timing signal used to generate the clock signal.

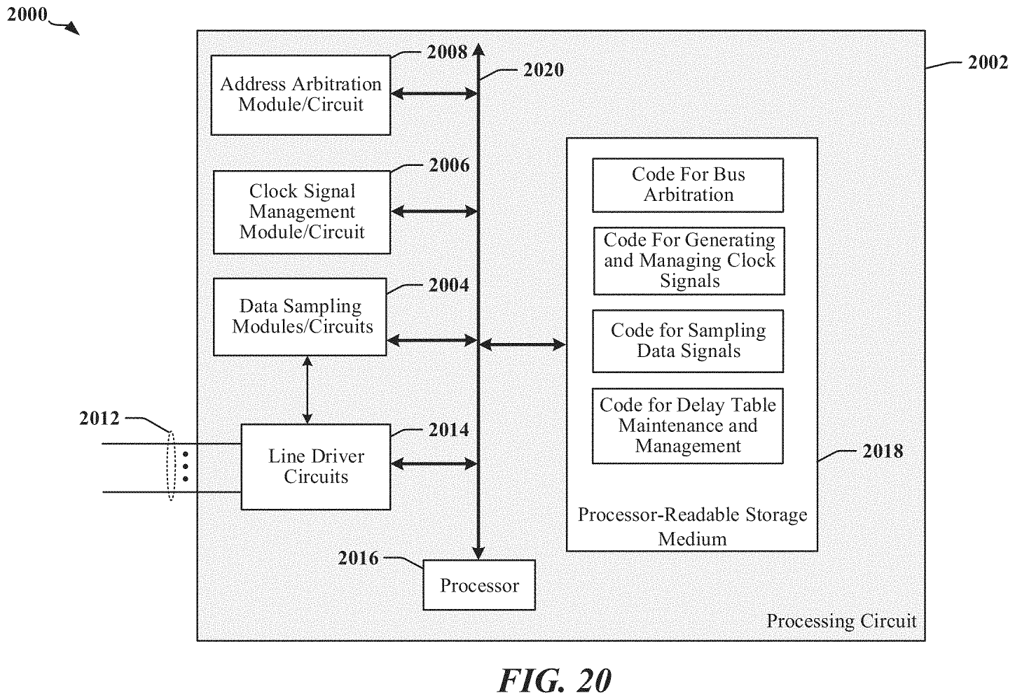

FIG. 20 is a diagram illustrating an example of a hardware implementation for an apparatus 2000 employing a processing circuit 2002. In one example, the apparatus 2000 is configured for data communication over a serial bus that is operated in accordance with one or more I3C protocols. The processing circuit typically has a controller or processor 2016 that may include one or more microprocessors, microcontrollers, digital signal processors, sequencers and/or state machines. The processing circuit 2002 may be implemented with a bus architecture, represented generally by the bus 2020. The bus 2020 may include any number of interconnecting buses and bridges depending on the specific application of the processing circuit 2002 and the overall design constraints. The bus 2020 links together various circuits including one or more processors and/or hardware modules, represented by the controller or processor 2016, the modules or circuits 2004, 2006 and 2008, and the processor-readable storage medium 2018. The apparatus may be coupled to a multi-wire communication link using a physical layer circuit 2014. The physical layer circuit 2014 may operate the multi-wire serial bus 2012 to support communications in accordance with I3C protocols. The bus 2020 may also link various other circuits such as timing sources, peripherals, voltage regulators, and power management circuits, which are well known in the art, and therefore, will not be described any further.

The processor 2016 is responsible for general processing, including the execution of software, code and/or instructions stored on the processor-readable storage medium 2018. The computer-readable storage medium may include a non-transitory storage medium. The software, when executed by the processor 2016, causes the processing circuit 2002 to perform the various functions described supra for any particular apparatus. The computer-readable storage medium may be used for storing data that is manipulated by the processor 2016 when executing software. The processing circuit 2002 further includes at least one of the modules 2004, 2006 and 2008. The modules 2004, 2006 and 2008 may be software modules running in the processor 2016, resident/stored in the processor-readable storage medium 2018, one or more hardware modules coupled to the processor 2016, or some combination thereof. The modules 2004, 2006 and 2008 may include microcontroller instructions, state machine configuration parameters, or some combination thereof.

In one configuration, the apparatus 2000 includes physical layer circuit 2014 that may include one or more line driver circuits including a first line driver coupled to a first wire of a multi-wire serial bus and a second line driver coupled to a second wire of the multi-wire serial bus 2012. In one example, the apparatus 2000 includes modules and/or circuits 2008 configured to arbitrate between devices contending for access to the serial bus, modules and/or circuits 2006 configured to manage clock signals and sampling signals, including configuring sampling delays. The apparatus 2000 may include modules and/or circuits 2004 configured to sample data signals using timing information provided by the modules and/or circuits 2006 configured to manage clock signals and sampling signals.

In one example, the apparatus 2000 includes a processor 2016 configured to provide a clock signal, determine a winning device based on an address received from a second line of the serial bus during a bus arbitration procedure, determine a first sampling point for sampling a first data signal that is received from the second line of the serial bus based on timing of the clock signal and a first delay value corresponding to the winning device, and capture a first bit of data from the second line of the serial bus at the sampling point.

The processor 2016 may be further configured to determine a second sampling point for sampling a second data signal that is received from a third line of the serial bus based on timing of the clock signal and a second delay value corresponding to the winning device, and capture a second bit of data from the third line of the serial bus at the second sampling point. The first sampling point may be coincident with the second sampling point or a delay may be provided between the first sampling point and the second sampling point.

In some instances, the processor 2016 may be further configured to delay the first data signal using a delay line, and capture the first bit of data from an output of the delay line that is selected using the first delay value. The first delay value may be expressed as a number of cycles of a timing signal used to generate the clock signal. The first delay value may be expressed as a number of edges in a timing signal used to generate the clock signal. The serial bus may be operated in accordance with one or more I3C protocols.

In another example, the processor-readable storage medium 2018 may store, maintain or otherwise include code which, when executed by the processor 2016, causes the processor 2016 to provide a clock signal on a first line of a serial bus, determine a winning device based on an address received from a second line of the serial bus during a bus arbitration procedure, determine a first sampling point for sampling a first data signal that is received from the second line of the serial bus based on timing of the clock signal and a first delay value corresponding to the winning device, and capture a first bit of data from the second line of the serial bus at the sampling point.

The processor-readable storage medium 2018 may include code that causes the processor 2016 to determine a second sampling point for sampling a second data signal that is received from a third line of the serial bus based on timing of the clock signal and a second delay value corresponding to the winning device, and capture a second bit of data from the third line of the serial bus at the second sampling point.

In some instances, the first sampling point is coincident with the second sampling point. In other instances, a delay is provided between the first sampling point and the second sampling point.

The processor-readable storage medium 2018 may include code that causes the processor 2016 to delay the first data signal using a delay line, and capturing the first bit of data from an output of the delay line that is selected using the first delay value. In one example, the first delay value may be expressed as a number of cycles of a timing signal used to generate the clock signal. In another example, the first delay value is expressed as a number of edges in a timing signal used to generate the clock signal. The serial bus may be operated in accordance with one or more I3C protocols.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for data communication comprising:
providing a clock signal on a first line of a serial bus;
determining a winning device based on an address received from a second line of the serial bus during a bus arbitration procedure;
determining a first sampling point for sampling a first data signal that is received from the second line of the serial bus based on timing of the clock signal and a first delay value corresponding to the winning device; and
capturing a first bit of data from the second line of the serial bus at the first sampling point.

2. The method of claim 1, further comprising:
determining a second sampling point for sampling a second data signal that is received from a third line of the serial bus based on the timing of the clock signal and a second delay value corresponding to the winning device; and
capturing a second bit of data from the third line of the serial bus at the second sampling point.

3. The method of claim 2, wherein the first sampling point is coincident with the second sampling point.

4. The method of claim 2, wherein a delay is provided between the first sampling point and the second sampling point.

5. The method of claim 1, further comprising:
delaying the first data signal using a delay line; and
capturing the first bit of data from an output of the delay line that is selected using the first delay value.

6. The method of claim 1, wherein the first delay value is expressed as a number of cycles of a timing signal used to generate the clock signal.

7. The method of claim 1, wherein the first delay value is expressed as a number of edges in a timing signal used to generate the clock signal.

8. The method of claim 1, wherein the serial bus is operated in accordance with an I3C protocol.

9. An apparatus adapted for data communication, comprising:
a bus interface configured to couple the apparatus to a serial bus having a first line configured to carry a clock signal and a second line configured to carry a first data signal; and
a processor configured to:
provide the clock signal;
determine a winning device based on an address received from the second line of the serial bus during a bus arbitration procedure;
determine a first sampling point for sampling a first data signal that is received from the second line of the serial bus based on timing of the clock signal and a first delay value corresponding to the winning device; and
capture a first bit of data from the second line of the serial bus at the first sampling point.

10. The apparatus of claim 9, wherein the processor is further configured to:
determine a second sampling point for sampling a second data signal that is received from a third line of the serial bus based on the timing of the clock signal and a second delay value corresponding to the winning device; and
capture a second bit of data from the third line of the serial bus at the second sampling point.

11. The apparatus of claim 10, wherein the first sampling point is coincident with the second sampling point.

12. The apparatus of claim 10, wherein a delay is provided between the first sampling point and the second sampling point.

13. The apparatus of claim 9, wherein the processor is further configured to:
delay the first data signal using a delay line; and
capture the first bit of data from an output of the delay line that is selected using the first delay value.

14. The apparatus of claim 9, wherein the first delay value is expressed as a number of cycles of a timing signal used to generate the clock signal.

15. The apparatus of claim 9, wherein the first delay value is expressed as a number of edges in a timing signal used to generate the clock signal.

16. The apparatus of claim 9, wherein the serial bus is operated in accordance with an I3C protocol.

17. A processor-readable storage medium including code which, when executed by a processor, causes the processor to:
provide a clock signal on a first line of a serial bus;
determine a winning device based on an address received from a second line of the serial bus during a bus arbitration procedure;
determine a first sampling point for sampling a first data signal that is received from the second line of the serial bus based on timing of the clock signal and a first delay value corresponding to the winning device; and
capture a first bit of data from the second line of the serial bus at the first sampling point.

18. The storage medium of claim 17, further comprising code that causes the processor to:
determine a second sampling point for sampling a second data signal that is received from a third line of the serial bus based on the timing of the clock signal and a second delay value corresponding to the winning device; and
capture a second bit of data from the third line of the serial bus at the second sampling point.

19. The storage medium of claim 18, wherein the first sampling point is coincident with the second sampling point.

20. The storage medium of claim 18, wherein a delay is provided between the first sampling point and the second sampling point.

21. The storage medium of claim 17, further comprising code that causes the processor to:
delay the first data signal using a delay line; and
capture the first bit of data from an output of the delay line that is selected using the first delay value.

22. The storage medium of claim 17, wherein the first delay value is expressed as a number of cycles of a timing signal used to generate the clock signal.

23. The storage medium of claim 17, wherein the first delay value is expressed as a number of edges in a timing signal used to generate the clock signal.

24. The storage medium of claim 17, wherein the serial bus is operated in accordance with an I3C protocol.

25. An apparatus adapted for data communication, comprising:
means for transmitting a clock signal over a first line of a serial bus;
means for determining a winning device based on an address received from a second line of the serial bus during a bus arbitration procedure;
means for determining a first sampling point for sampling a first data signal that is received from the second line of the serial bus based on timing of the clock signal and a first delay value corresponding to the winning device; and
means for capturing a first bit of data from the second line of the serial bus at the first sampling point.

26. The apparatus of claim 25, further comprising:
means for determining a second sampling point for sampling a second data signal that is received from a third line of the serial bus based on the timing of the clock signal and a second delay value corresponding to the winning device; and
means for capturing a second bit of data from the third line of the serial bus at the second sampling point.

27. The apparatus of claim 26, wherein the first sampling point is coincident with the second sampling point.

28. The apparatus of claim 26, wherein a delay is provided between the first sampling point and the second sampling point.

29. The apparatus of claim 25, further comprising:
means for delaying the first data signal; and
means for capturing the first bit of data from an output of the means for delaying that is selected using the first delay value.

30. The apparatus of claim 25, wherein the first delay value is expressed as a number of cycles of a timing signal used to generate the clock signal, or the first delay value is expressed as a number of edges in the timing signal used to generate the clock signal.
